(19) United States
(12) Patent Application Publication
(10) Pub. No.: US 2005/0058039 A1
(43) Pub. Date: Mar. 17, 2005

(54) Multi-standard optical disk and method and apparatus of reading from and recording to the disk

(76) Inventor: Yasuo Kamatani, Tokyo (JP)

Correspondence Address: HAMILTON & TERRILE, LLP, P.O. BOX 203518, AUSTIN, TX, 78720, US

(21) Appl. No.: 10/976,294

(22) Filed: Oct. 27, 2004

Related U.S. Application Data
(63) Continuation of application No. 09/393,573, filed on Sep. 10, 1999.
Application No. 09/393,573 is a continuation-in-part of application No. 08/786,372, filed on Jan. 16, 1997, now Pat. No. 5,959,280.

(51) Int. Cl. G11B 5/09

(52) U.S. Cl. 369/53.2; 369/47.21; 369/59.25

(57) ABSTRACT

An optical disk includes a data structure that includes a format identification region that includes details of data storage. For example, in some embodiments, the data structure may include first data that is indicative of a number of data layers of the optical disk; second data that is indicative of a data transfer rate; and third data that is indicative of a recording density. In other embodiments, the data that indicates the details of data storage may include, as examples, data that indicates a laser source modulation code that is used to record data on the optical disk and may include data that indicates a laser source modulation code that is used to retrieve data from the optical disk. In some embodiments, a servomechanism may be controlled based on this data to record and/or retrieve data from the optical disk. As examples, in different embodiments, the optical disk may be a DVD-R disk, a DVD-RAM or a DVD-ROM disk, as just a few examples.

This is a continuation-in-part of U.S. patent application Ser. No. 08/786,372, entitled “MULTI-STANDARD OPTICAL DISK READING APPARATUS AND METHOD OF READING USING SAME,” filed on Jan. 16, 1997.

### BACKGROUND

This invention relates to an optical data storage system. More specifically, this invention relates to an optical reading apparatus and related method for an optical data reproducing system which is able to reproduce encoded data at different pit density on varied types of optical disk formats.

Initialized by the vast increase in information that needs to be processed, optical data storage systems have become very important, particularly because of their high storage density per unit area. Most of the recent optical information storage systems use a rotating single optical disk on which the information is digitally stored in concentric circular tracks in an ordered, predefined manner to allow chronological fast reading and fast random access to desired pits of data.

At present, varied types of optical disk systems are provided such as, as examples, the compact disk (CD) system, the Mini-Disk (MD) system and the multi-layered optical disk for digital video disk (DVD) system. Each of these system types use a optical disk format that is fabricated dependent upon a different standard, and the thickness or pit density of the optical disks are different from one another. Thus, an optical reading system is needed which is able to reproduce the encoded data from any type of optical disk format.

### SUMMARY

In one embodiment of the invention, an optical disk includes a data structure that includes a format identification region that includes details of data storage. For example, in some embodiments, the data structure may include first data that is indicative of a number of data layers of the optical disk; second data that is indicative of a data transfer rate; and third data that is indicative of a recording density. In other embodiments, the data that indicates the details of data storage may include, as examples, data that indicates a laser source modulation code that is used to record data on the optical disk and may include data that indicates a laser source modulation code that is used to retrieve data from the optical disk. In some embodiments, a servomechanism may be controlled based on this data to record and/or retrieve data from the optical disk. As examples, in different embodiments, the optical disk may be a DVD-R disk, a DVD-RAM or a DVD-ROM disk, as just a few examples.

For a fuller understanding of the nature and advantages of the present invention reference should be made to the following detailed description taken in conjunction with the accompanying drawings.

### BRIEF DESCRIPTION OF THE DRAWING

FIG. 1 is a block diagram of a first example of an optical reading apparatus to which the present invention can be applied;

FIG. 2(a) is a block diagram of a second example of an optical reading apparatus to which the present invention can be applied;

FIG. 2(b) shows a structure of an optical disk which is used in the optical reading apparatus of the present invention described in FIG. 2(a); and

FIG. 2(c) shows a structure of an optical disk reading system which is applicable to the optical reading apparatus of the present invention illustrated in FIG. 2(a).

### DETAILED DESCRIPTION

Embodiments of the present invention will be explained with reference to the drawings.

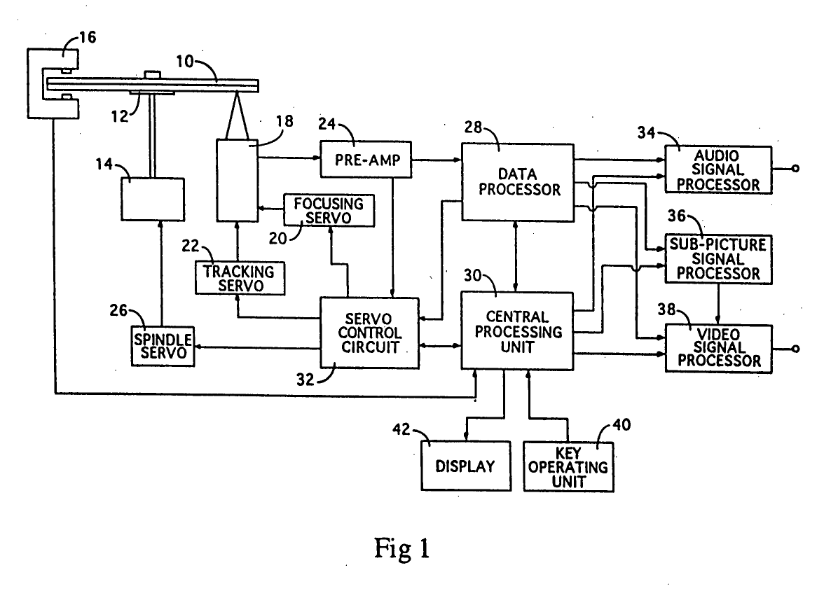

FIG. 1 is a block diagram of a first example of an optical reading apparatus to which the optical disk reading methods of the present invention can be applied. An optical disk 10 represents one of the optical disk formats among a compact disk (CD), a Mini-Disk (MD), a digital video disk (DVD) or any other. The optical disk 10 is mounted on and secured by a turntable 12 to be rotated by a spindle motor 14. And the total number of data layers or thickness of the optical disk 10 is detected by a photo-interrupter 16 to distinguish the standard and type of the optical disk 10. Encoded pits on the optical disk 10 are read by a pickup 18 which includes a laser diode, a focusing lens, a focusing lens actuator, a tracking actuator and a photo-detector. The output signal from the pickup 18 is transmitted to a focusing servo circuit 20, a tracking servo circuit 22 and a pre-amplifier 24. According to a focusing error signal, the focusing servo circuit 20 modulates the focusing lens actuator to move the focusing lens, and according to a tracking error signal, the tracking servo circuit 22 modulates the tracking actuator to move the pickup 18. The spindle servo circuit 26 modulates the spindle motor 14 in order to track the linear velocity of the optical disk 10.

The output signal applied to the pre-amplifier 24 from the pickup 18 is transmitted to a data processor 28. Then the decoded signal is processed by a central processing unit 30 (CPU). The CPU 30 also processes a detected signal from the photo-interrupter 16 to identify the standard or type of the optical disk 10. The CPU 30 references the detected signal to stored data about the standard of various optical disk formats, in order to distinguish the standard of the optical disk 10. After the standard of the optical disk 10 is identified, a servo control circuit 32 determines the position of, or selects the focusing lens, by modulating the focusing servo circuit 20, and the tracking servo circuit 22 is modulated to move the pickup 18 in order to trace the pit lane which is fabricated in accordance with the pit density standard.

According to the identified standard of the optical disk 10, the CPU operates the data processor 28 to select an appropriate data encoding circuit in the data processor 28. Then the output signal amplified by the pre-amplifier 24 is decoded by the data processor 28, and the decoded signal is transmitted to an audio processor 34, a sub-picture processor 36 and a video processor 38. The audio processor 34, a sub-picture processor 36 and the video processor 38 are controlled by the CPU 30. The CPU 30 is operated by an operation signal from a key operating unit 40 which transmits all operating signals of an operator. The CPU 30 also controls a display unit 42 to show the status of data reproduction also controls a display unit 42 to show the status of data reproduction to the operator.

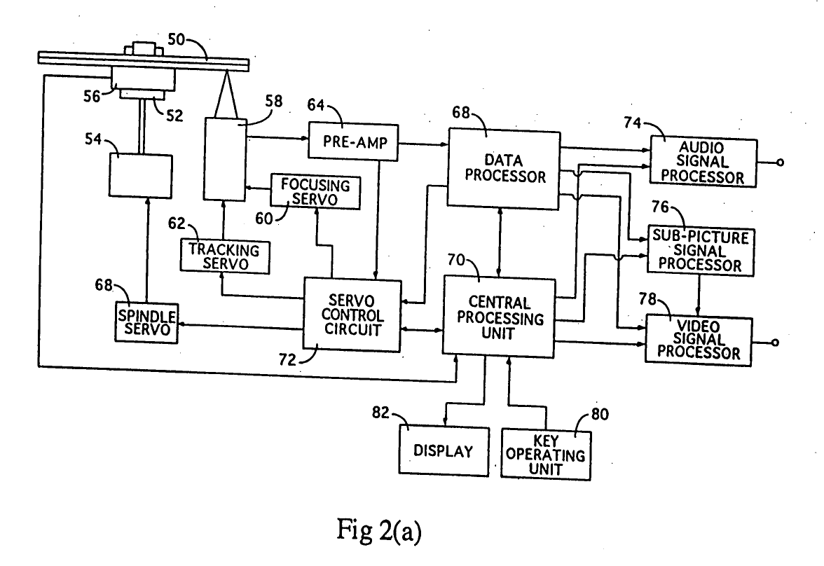

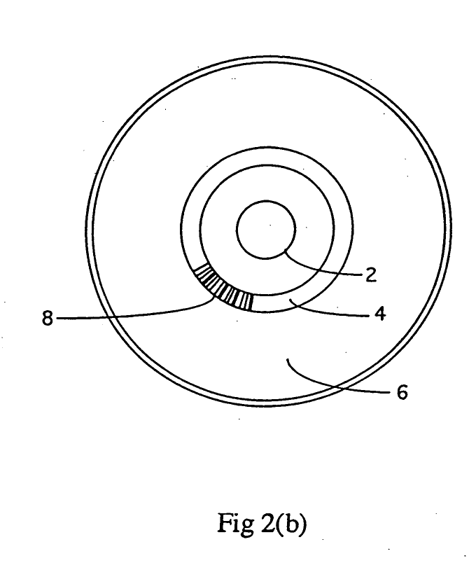

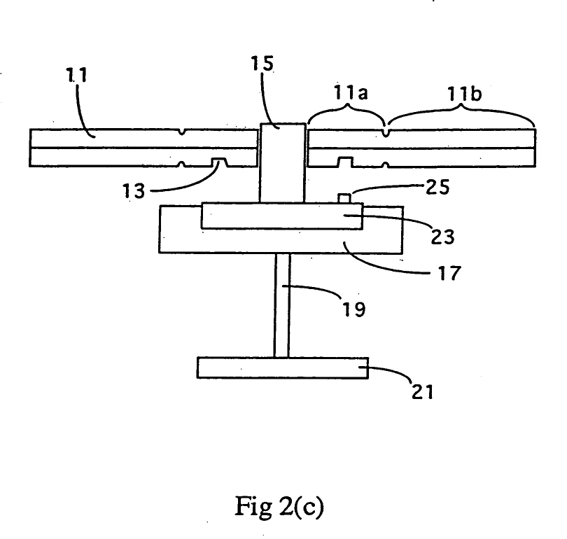

FIG. 2(a) is a block diagram of a second example of an optical reading apparatus to which the optical disk reading methods of the present invention can be applied. A sensing device is used differently from the apparatus described in FIG. 1. An optical disk 50 represents one of the optical disk formats among a compact disk (CD), a Mini-Disk (MD), a digital video disk (DVD) or any other. And the optical disk 50 has an identification mark at its label region, as illustrated in FIG. 2(b). The identification mark is referential to the standard of the optical disk 50. The optical disk 50 is mounted on and secured by a turntable 52 to be rotated by a spindle motor 54. The identification mark of the optical disk 50 is detected by a photo-sensor 56 to distinguish the standard and type of the optical disk 50. Encoded pits on the optical disk 50 are read by a pickup 58 which includes a laser diode, a focusing lens, a focusing lens actuator, a tracking actuator and a photo-detector. The output signal from the pickup 58 is transmitted to a focusing servo circuit 60, a tracking servo circuit 62 and a pre-amplifier 64. According to a focusing error signal, the focusing servo circuit 60 modulates the focusing lens actuator to move the focusing lens. And according to a tracking error signal, the tracking servo circuit 62 modulates the tracking actuator to move the pickup 58. The spindle servo circuit 66 modulates the spindle motor 54 in order to track the linear velocity of the optical disk 50.

The output signal applied to the pre-amplifier 64 for the pickup 58, is transmitted to a data processor 68. Then the decoded signal is processed by a central processing unit 70 (CPU). The CPU 70 also processes the detected signal for the photo-sensor 56 to identify the standard or type of the optical disk 50. The CPU 70 references the detected signal to stored data about the standard of varied optical disk format, in order to distinguish the standard of the optical disk 50. After the standard of the optical disk 50 is identified, a servo control circuit 72 determines the position of, or selects the focusing lens by modulating the focusing servo circuit 60, and the tracking servo circuit 62 is modulated to move the pickup 58 in order to trace the pit lane which is fabricated in accordance with the pit density standard (which is among the details of how data is stored on the disk).

According to the identified standard of the optical disk 50, the CPU 70 operates the data processor 68 to select an appropriate data encoding circuit in the data processor 68. Then the output signal amplified by the pre-amplifier 64 is decoded by the data processor 68. And the decoded signal is transmitted to an audio processor 74, a sub-picture processor 76 and a video processor 78. The audio processor 74, the sub-picture processor 76 and the video processor 78 are controlled by the CPU 70. The CPU 70 is operated by an operation signal from a key operating unit 80 which transmits all operating signals of an operator. The CPU 70 also controls a display unit 82 to show the status of data reproduction to the operator.

FIG. 2(b) shows a structure of an optical disk which is applicable to the optical reading apparatus of the present invention described above with respect to FIG. 2(a). An optical disk has a center hole 2, label region 4 and encoded data region 6. An identification mark 8 is placed in the label region 4 to be detected by the photo-sensor 56 in FIG. 2(a). And the identification mark is referential to the standard of the optical disk. It represents data as to the total number of data encoded layers and the data reproduction, in order to set up the movement of the servo mechanisms.

FIG. 2(c) shows a structure of an optical disk reading system which is applicable to the optical reading apparatus of the present invention illustrated in FIG. 2(a). An optical disk 11 has a label region 11a and a data encoded region 11b. An optical disk 11 is one of the optical disk formats among a compact disk (CD), a Mini-Disk (MD), a digital video disk (DVD), or any other. And the type or standard of the optical disk 11 is distinguished by an identification groove 13. The optical disk 11 is secured by a center pivot 15, and mounted on a turntable 17 to be rotated by a spindle shaft 19 which is driven by a spindle motor 21. A touch-sensing device 23 is mounted on the turntable 17. And the identification groove 13 is detected by a touch-pin 25 of the touch-sensing device 23. After the standard of the optical disk 11 is identified to set up the movement of servo mechanisms or a data processor, the data reproduction is started.

In some embodiments, the following data may be recorded by a manufacturer of the optical disk in a predefined area on the optical disk to identify the standard or type of the optical disk. In this manner, the pick-up may detect this data to identify the standard or type of the optical disk, and the processor may not need to use a look-up table in order to recognize the standard or type of the optical disk As an example, the predefined area may be located in the label region of the optical disk. However, the predefined area may be located in another region of the disk.

As examples, in some embodiments, the data that is stored in the predefined area of the disk may include data that indicates a number of data layers of the optical disk; data that indicates a data transfer rate; data that indicates a recording density; data that indicates whether the optical disk is adapted to provide either a read-only format or a re-writable format; data indicative of a size of the read-only/rewritable format; data indicative of a laser source modulation code used to record data on the optical disk; and data indicative of a laser source modulation code used to retrieve data from the optical disk. Thus, the data identifies the details of data storage on the optical disk. The servomechanism of the disk drive may be controlled based on this information to retrieve data from and/or record data to the optical disk.

The optical disk may be, as examples, a DVD-RAM disk, a DVD-R disk or a DVD-ROM disk.

Although the invention has been particularly shown and described, it is contemplated that various changes and modifications may be made without departing from the scope of the invention as set forth in the following claims.

1-31. (Cancelled).

32. An optical disk comprising an identification mark at a label region of the optical disk, where the identification mark represents a standard of the optical disk that is detectable by an optical reading means to identify a number of layers and recording density standard of the optical disk

33. An optical disk comprising multi-layered recording region and an identification mark region at a label region of the optical disk, where the identification mark refers to a standard of the optical disk and is detectable by an optical reading means to identify a total number of layers and a recording density standard of the optical disk.
